(19) United States
(12) Patent Application Publication
(10) Pub. No.: US 2026/0331940 A1
(43) Pub. Date: Oct. 22, 2026

(54) SYNCHRONOUS BUCK CHARGING CIRCUIT WITHOUT EXTERNAL SAMPLING RESISTOR AND CURRENT SAMPLING CONTROL METHOD FOR LOSS OPTIMIZATION

(71) Applicant: Shenzhen Oriental Willing New Energy Co., Ltd, Shenzhen (CN)

(72) Inventor: KUNLI WANG, Zunyi (CN)

(21) Appl. No.: 19/711,174

(22) Filed: Jun. 17, 2026

(30) Foreign Application Priority Data
Jun. 8, 2026 (CN) 202610814784.4

(51) Int. Cl. H02J 7/90; H02J 7/80

(52) U.S. Cl. CPC H02J 7/933; H02J 7/80; H02J 2207/20

(57) ABSTRACT

Provided are a synchronous buck charging circuit without external sampling resistors and a current sampling control method for loss optimization; the present disclosure integrates an inductor current sampling module, which samples the currents of the high and low side power transistors in a time-sharing manner and combines them into a continuous inductor current waveform, thereby replacing the external power sampling resistor in traditional solutions. On the premise of ensuring the accuracy of charging current control, the approximately 122.5 mW conduction loss caused by the sampling resistor during high current charging has been completely eliminated, thereby reducing system temperature rise and improving charging safety and battery life; at the same time, eliminating the resistor that simplifies the peripheral circuit, reduces the PCB footprint, lowers material costs, and achieves efficient, highly integrated, and low-cost synchronous buck charging management.

### CROSS-REFERENCE TO RELATED APPLICATIONS

This application claims priority to Chinese Patent Application No. 202610814784.4, filed on Jun. 8, 2026, which is hereby incorporated by reference in its entirety.

### TECHNICAL FIELD

The present disclosure relates to the field of power electronics technologies, and in particular, to a synchronous buck charging circuit without external sampling resistor and a current sampling control method for loss optimization.

### BACKGROUND

With the popularity of portable electronic devices, single cell lithium batteries are widely used in fields such as smartphones, tablets, and wearable devices due to their high energy density. To provide charging management for single lithium batteries in the above-mentioned devices, a synchronous buck charging chip (Switching Charger) is usually used to convert the standard 5V USB input power supply into a charging voltage and current suitable for lithium batteries.

In the traditional application structure of synchronous buck charging chips, in order to ensure the accuracy of charging current in constant current mode and trickle current mode, a milliohm level precision sampling resistor (Rs, typical value of 10 m Ω) needs to be connected in series in the power main circuit to sample the charging current and feedback the sampling signal to the charging control module inside the chip, thereby achieving loop regulation of the charging current.

However, the traditional approach mentioned above has the problem that when charging the battery with high power, such as when the charging current reaches 3.5 A, the conduction loss (P=I²×Rs=3.5²×0.01=122.5 mW) generated on the sampling resistor will dissipate in the form of thermal energy, rising the system temperature and conducting it to the battery, and thereby affecting charging safety.

Besides that, the sampling resistor is a power resistor with a certain physical volume, which is not conducive to the design of volume sensitive miniaturized systems. Adding sampling resistors will also increase the cost of the system's bill of materials.

Therefore, in response to the technical problems mentioned above, it is urgent to develop and design a synchronous buck charging circuit without external sampling resistors and a current sampling control method for loss optimization.

### SUMMARY

To overcome the shortcomings and difficulties of the existing technologies mentioned above, the purpose of the present disclosure is to propose a synchronous buck charging circuit without external sampling resistors and a current sampling control method for loss optimization so as to eliminate external sampling resistors while ensuring the accuracy of charging current control, and achieve efficient, highly integrated, and low-cost charging management.

A first objective of the present disclosure is to provide a synchronous buck charging circuit without external sampling resistors; a second objective of the present disclosure is to provide a current sampling control method for loss optimization; a third objective of the present disclosure is to provide a charging management chip; a fourth objective of the present disclosure is to provide an electronic device.

The first objective of the present disclosure is achieved as follows: the synchronous buck charging circuit without external sampling resistors includes connection nodes configured to be coupled to a high side power transistor and a low side power transistor through an external inductor; and an inductor current sampling module with a first input terminal coupled to a current terminal of the high side power transistor for time-sharing sampling of a first current of the high side power transistor, and a second input terminal coupled to a current terminal of the low side power transistor for time-sharing sampling of a second current of the low side power transistor; where the inductor current sampling module is configured to synthesize the first current and the second current sampled in a time-sharing manner into a continuous inductance current sensing signal;
where the synchronous buck charging circuit further includes an input terminal configured to receive the inductance current sensing signal, and an output terminal configured to drive the charging control module of the high side power transistor and the low side power transistor respectively; where the charging control module adjusts a charging current based on the inductance current sensing signal;
where the synchronous buck charging circuit is configured to be without an external current sampling resistor to eliminate conduction losses on the sampling resistor.

In some embodiments of the present disclosure, the inductor current sampling module further includes a high side sampling unit, a low side sampling unit, and a synthesis unit;
where the high side sampling unit is connected in parallel or mirrored with the high side power transistor and is configured to output a first sampling current proportional to its conduction current during a conduction period of the high side power transistor;
where the low side sampling unit is connected in parallel or mirrored with the low side power transistor and is configured to output a second sampling current proportional to its conduction current during a conduction period of the low side power transistor;
where the synthesis unit receives the first sampling current and the second sampling current respectively and splices them in a time domain into a continuous synthesis current, and the synthesis current represents an instantaneous current of the external inductor.

In some embodiments of the present disclosure, the synthesis unit includes a common resistor;
the first sampling current and the second sampling current selectively flow through the common resistor, thereby generating a voltage signal corresponding to the continuous inductance current sensing signal at both ends.

In some embodiments of the present disclosure, the charging control module includes a current loop error amplifier; where a first input terminal of the current loop error amplifier receives a reference voltage representing a target charging current, a second input terminal of the current loop error amplifier receives a feedback voltage converted from the inductance current sensing signal, and an output of the current loop error amplifier is configured to control a Pulse-Width Modulation, (PWM) duty cycle.

The second objective of the present disclosure is achieved by the method including the steps of:
during a first phase of a switching cycle, sampling a current flowing through the high side power transistor to obtain a first current sample;
during a second phase of the switching cycle, sampling a current flowing through the low side power transistor to obtain a second current sample, where the first phase does not overlap with the second phase and essentially covers the entire switching cycle;
continuously splicing the first current sample and the second current sample in time to reconstruct a complete inductor current waveform; and
using a reconstructed inductor current waveform or its average value as a feedback signal for the charging current to adjust the charging current and achieve loss optimization.

In some embodiments of the present disclosure, the method further includes:
converting the spliced current signal into a voltage signal, and feeding back the voltage signal to a charging control loop to adjust conduction times of the high side power transistor and the low side power transistor.

The third objective of the present disclosure is achieved by integrating the synchronous buck charging circuit without external sampling resistors into the charging management chip.

In some embodiments of the present disclosure, the chip only needs to be equipped with external components at its power input terminal, power ground terminal, switch node terminal, and battery connection terminal, without the need to equip with sampling resistors for current detection.

The fourth objective of the present disclosure is achieved as follows: the electronic device includes the charging management chip; a standard 5V USB power interface; a single cell lithium battery; and
an external circuit that only includes an inductor, an input capacitor, and an output capacitor, where a switch node of the chip is coupled to the lithium battery through the inductor, and an input terminal of the chip receives a USB power supply.

In some embodiments of the present disclosure, the charging management chip is configured to provide a maximum charging current of 3.5 A to the single lithium battery, and there is no additional conduction loss caused by external power resistors on its internal current sampling path.

The present disclosure integrates the inductor current sampling module to time sample the currents of the high and low side power transistors and combine them into a continuous inductor current waveform, replacing the external power sampling resistor in traditional solutions. This completely eliminates the approximately 122.5 mW conduction loss caused by the sampling resistor during high current charging (such as 3.5 A) while ensuring the accuracy of charging current control, reducing system temperature rise and improving charging safety and battery life; at the same time, eliminating the power resistor simplifies the peripheral circuit, reduces the PCB footprint, lowers material costs, and achieves a high-efficiency, highly integrated, and low-cost synchronous buck charging management solution.

### BRIEF DESCRIPTION OF DRAWINGS

In order to provide a clearer explanation of the technical solution in the embodiments of the present disclosure, a brief introduction will be given to the drawings required for the description of the embodiments. It is obvious that the drawings described below are only some embodiments of the present disclosure. For those skilled in the art, other drawings can be obtained based on these drawings without creative work.

FIG. 1 is an application schematic diagram of a traditional Switching Charger.

FIG. 2 is a working principle schematic diagram of the Switching Charger in a synchronous buck charging circuit without external sampling resistors of the present disclosure.

FIG. 3 is a timing schematic diagram of M0 and M1 switches of the synchronous buck charging circuit without external sampling resistors of the present disclosure.

FIG. 4 is a timing diagram of an inductor current and M0, M1 of the synchronous buck charging circuit without external sampling resistors of the present disclosure.

FIG. 5 is a principal circuit schematic diagram of adding an inductor current sampling module to the synchronous buck charging circuit without external sampling resistors of the present disclosure.

FIG. 6 is a schematic diagram of an inductor current sampling circuit of the synchronous buck charging circuit without external sampling resistors of the present disclosure.

FIG. 7 is a schematic diagram of a Charger Control circuit of the synchronous buck charging circuit without external sampling resistors of the present disclosure.

FIG. 8 is a sampling circuit schematic diagram of M0 of the synchronous buck charging circuit without external sampling resistors of the present disclosure.

FIG. 9 is a sampling circuit schematic diagram of M1 of the synchronous buck charging circuit without external sampling resistors of the present disclosure.

FIG. 10 is an architecture schematic diagram of the synchronous buck charging circuit without external sampling resistors of the present disclosure.

FIG. 11 is a flow step schematic diagram of a current sampling control method for loss optimization of the present disclosure.

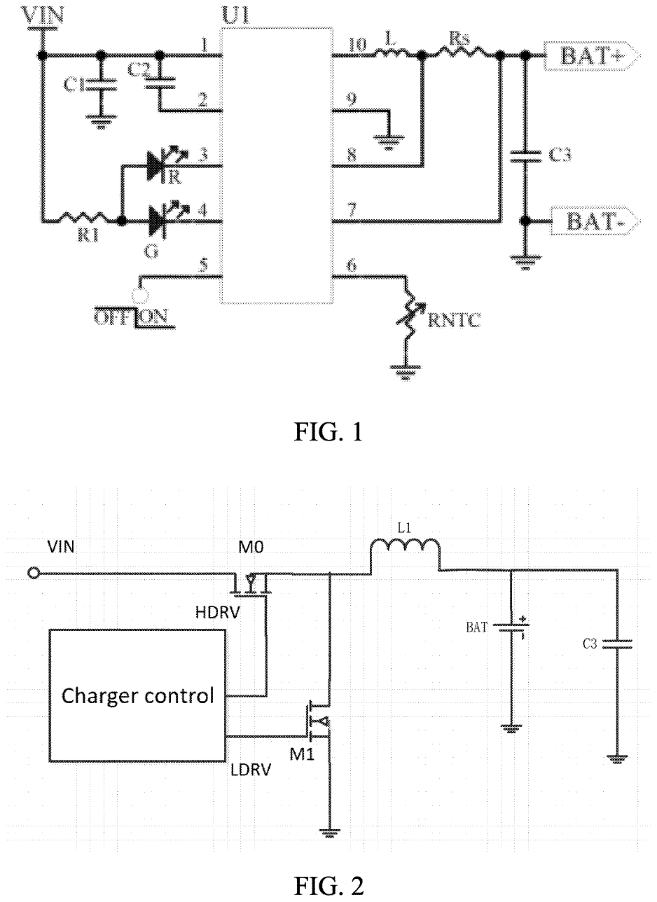

### DESCRIPTION OF EMBODIMENTS

In order to facilitate a better understanding of the purpose, technical solution, and advantages of the present disclosure, further explanation of the present disclosure is provided below in combination with the accompanying drawings and specific embodiments. Those skilled in the art can easily understand other advantages and effects of the present disclosure from the content disclosed in this specification.

The present disclosure can also be implemented or applied through other specific examples, and various details in this specification can be modified and changed based on different perspectives and applications without departing from the spirit of the present disclosure.

It should be noted that if directional indications (such as up, down, left, right, front, back, etc.) are involved in the embodiments of the present disclosure, the directional indications are only used to explain the relative position relationship and motion of the components in a specific posture (as shown in the figures). If the specific posture changes, the directional indications will also change accordingly.

Besides that, if there are descriptions related to “first”, “second”, etc. in the embodiments of the present disclosure, descriptions of “first”, “second”, etc. are only for descriptive purposes and cannot be understood as indicating or implying their relative importance or implying the number of technical features indicated. Therefore, the features that are limited to “first” and “second” can explicitly or implicitly include at least one of these features. Secondly, the technical solutions between various embodiments can be combined with each other, but they must be based on the ability of those skilled in the art to implement them. When the combination of technical solutions is contradictory or impossible to implement, it should be considered that this combination of technical solutions does not exist and is not within the protection scope of the present disclosure.

The present disclosure will be further elaborated in combination with the accompanying drawings.

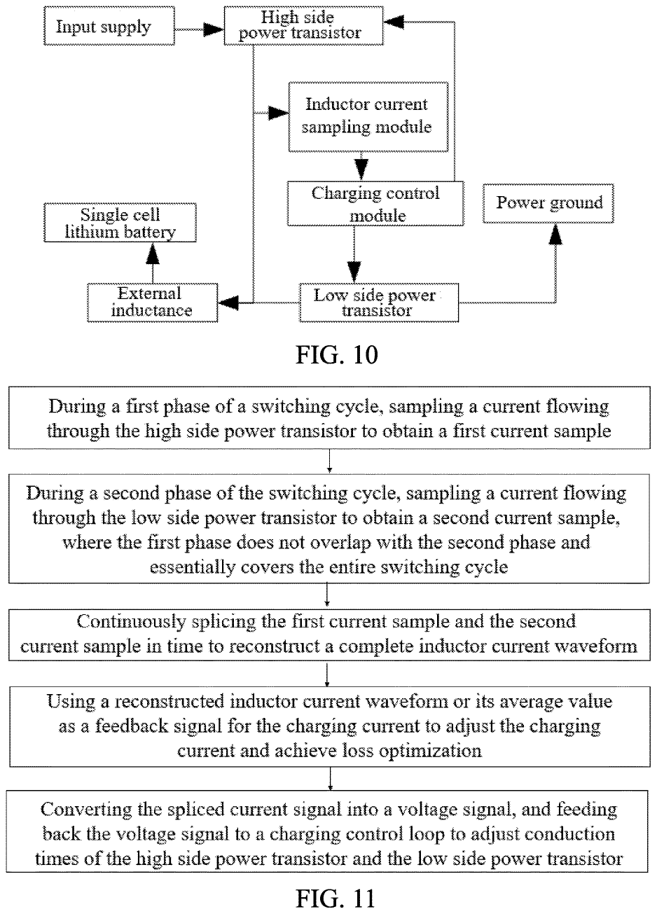

Referring to FIGS. 2-10, the present disclosure provides a synchronous buck charging circuit without external sampling resistors. The synchronous buck charging circuit includes connection nodes configured to be coupled to a high side power transistor and a low side power transistor through an external inductor; and an inductor current sampling module with a first input terminal coupled to a current terminal of the high side power transistor for time-sharing sampling of a first current of the high side power transistor, and a second input terminal coupled to a current terminal of the low side power transistor for time-sharing sampling of a second current of the low side power transistor; where the inductor current sampling module is configured to synthesize the first current and the second current sampled in a time-sharing manner into a continuous inductance current sensing signal.

The synchronous buck charging circuit further includes an input terminal configured to receive the inductance current sensing signal, and an output terminal configured to drive the charging control module of the high side power transistor and the low side power transistor respectively; where the charging control module adjusts a charging current based on the inductance current sensing signal.

The synchronous buck charging circuit is configured to be without an external current sampling resistor to eliminate conduction losses on the sampling resistor.

The inductor current sampling module further includes a high side sampling unit, a low side sampling unit, and a synthesis unit;
the high side sampling unit is connected in parallel or mirrored with the high side power transistor, and is configured to output a first sampling current proportional to its conduction current during a conduction period of the high side power transistor;
the low side sampling unit is connected in parallel or mirrored with the low side power transistor, and is configured to output a second sampling current proportional to its conduction current during a conduction period of the low side power transistor;
the synthesis unit receives the first sampling current and the second sampling current respectively, and splices them in a time domain into a continuous synthesis current, and the synthesis current represents an instantaneous current of the external inductor;
the synthesis unit includes a common resistor;
the first sampling current and the second sampling current selectively flow through the common resistor, thereby generating a voltage signal corresponding to the continuous inductance current sensing signal at two ends of the common resistor.

The charging control module includes a current loop error amplifier; where a first input terminal of the current loop error amplifier receives a reference voltage representing a target charging current, a second input terminal of the current loop error amplifier receives a feedback voltage converted from the inductance current sensing signal, and an output of the current loop error amplifier is configured to control a Pulse-Width Modulation, (PWM) duty cycle.

In an implementation mode of the present disclosure, the goal of chip design is to eliminate a Rs resistor, meet requirements of system miniaturization, high efficiency, and low cost, while ensuring the stability of charging current.

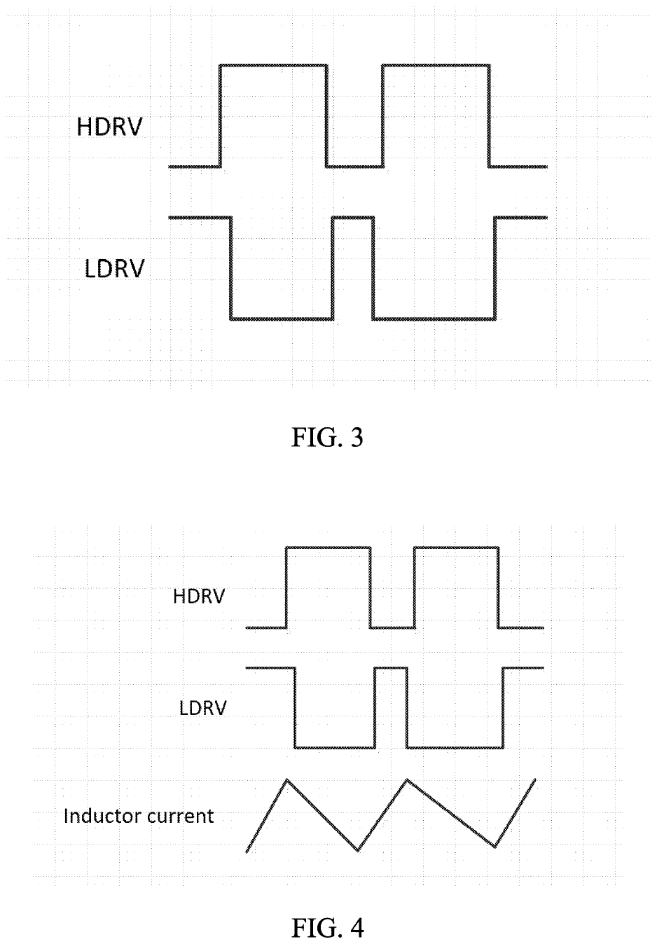

After removing the Rs sampling resistor, the charging current cannot be directly obtained, but the inductor current can be obtained through a certain method. From the application, it can be known that an average value of the inductor current is equal to an average value of the current on the Rs sampling resistor. The simple working principle of the Switching Charger is shown in FIG. 2. The “Charger Control” module uses feedback control to output HDRV and LDRV signals to control the turn off and on of M0 and M1, respectively. The timing of HDRV and LDRV is shown in FIG. 3. M0 and M1 are alternately opened and cannot be opened simultaneously. When M0 is turned on, M1 is turned off, and the inductor current is equal to the current flowing through M0. When M1 is turned on, M0 is turned off, and the inductor current is equal to the current flowing through M1. The waveform of the inductor current is shown in FIG. 4. The inductor current is the superposition of M0 current and M1 current, which is a triangular wave with an average current equal to the charging current.

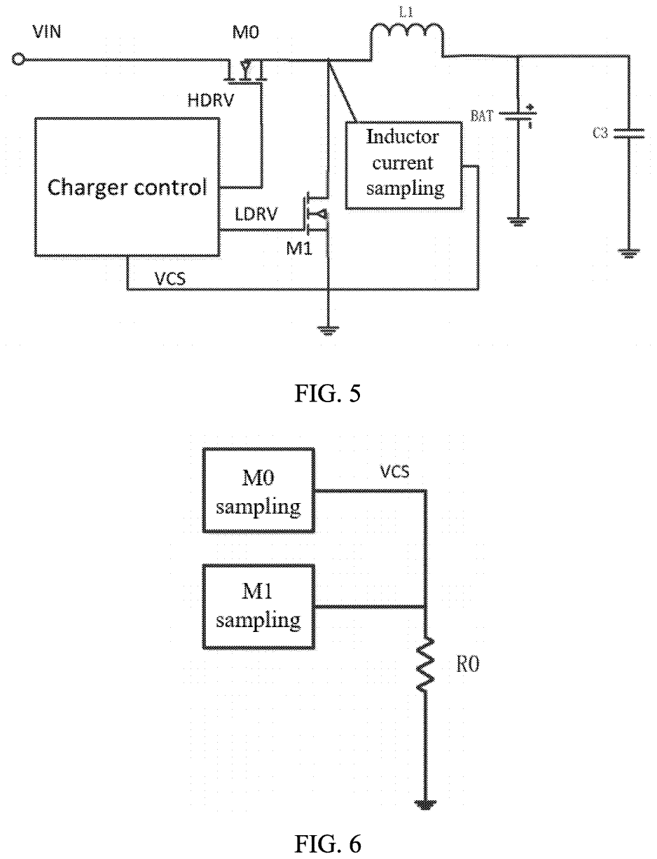

In order to obtain the charging current, it is necessary to fully sample the triangular wave of the inductor current to obtain the charging current. Therefore, an “inductor current sampling” module needs to be added to the charging chip. This module is used to sample the currents of M0 and M1 and combine the two currents to form the inductor current, which is fed back to the “Charger Control” module to control the charging current. The updated system diagram is shown in FIG. 5. After the inductor current is sampled, a voltage VCS is generated and fed back to the Charger Control, which controls the charging current through the feedback system.

The inductor current sampling module consists of two circuits, i.e., M0 sampling and M1 sampling. The sampled current flows through a resistor R0 to generate a VCS voltage, and this voltage represents the average current of the inductor. The circuit is shown in FIG. 6.

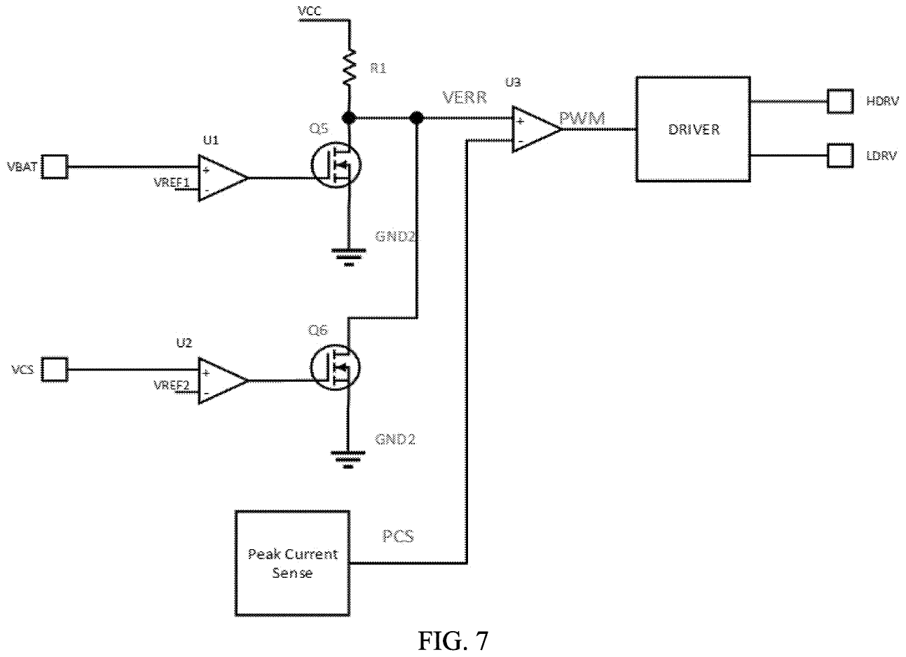

In the present disclosure, the “Charger Control” circuit is shown in FIG. 7, this module has two feedback signals VBAT and VCS. VBAT samples the battery voltage signal, while VCS samples the charging current signal. When VBAT is lower than a preset value of VREF1, Q5 is turned off and the ICC loop is activated. When ICC<VREF2, the VERR signal will increase, causing the duty cycle of the signal output by the U3 comparator to increase, thereby increasing the duty cycle of M0 in FIG. 2. The charging current is raised, causing VCS=VREF2, thus achieving the purpose of constant current charging. When VBAT=VREF1, the charging current will decrease and VCS will decrease, causing Q6 to shut down and Q5 to take effect. The feedback loop will make VBAT=VREF1, thus achieving constant voltage mode control of charging.

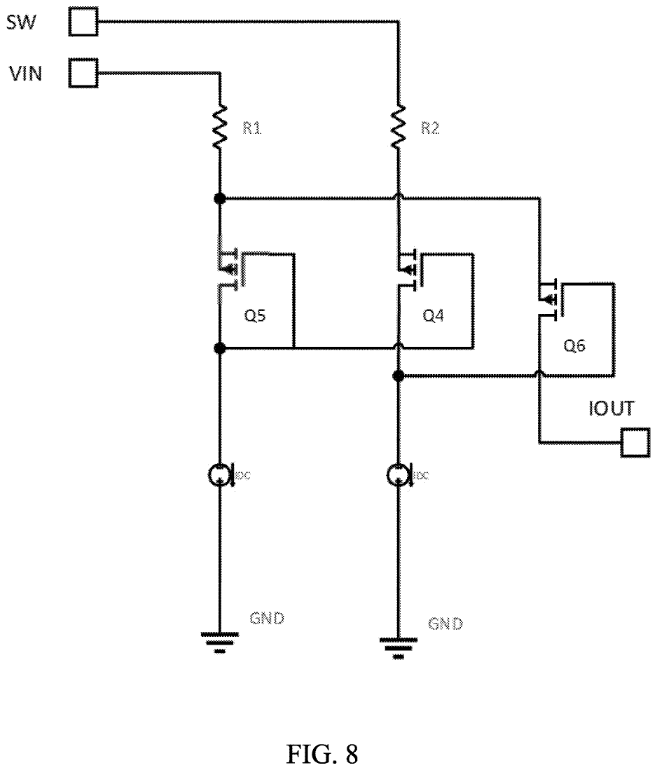

Referring to FIG. 8, it is the M0 sampling circuit diagram. VIN and SW are the two ends of M0 in FIG. 2. When M0 has current, it will cause a voltage difference between VIN and SW. A GATE of Q5 and a GATE of Q4 are connected together, and the current flowing through them is equal. Therefore, a VGS of Q5 and a VGS of Q4 are also equal, so IOUT=(VIN−SW)/R1 (R1=R2). From the formula, it can be seen that IOUT is related to a voltage difference between the two ends of M0. VIN−SW=IM0*RM0. For the system, RM0 and R1 are both determined quantities, so IOUT can represent IM0.

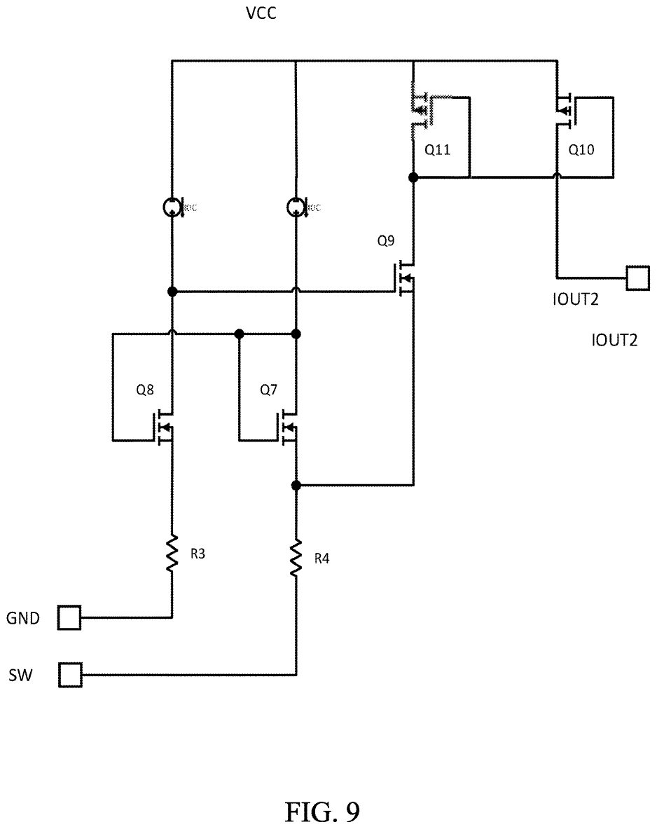

Referring to FIG. 9, it is the M1 sampling circuit diagram. When M1 in FIG. 2 is turned on and current flows through M1, a voltage drop GND-SW will be generated, and the direction of the current will make GND>SW. A GATE of Q7 and a GATE of Q8 are connected together, and the current flowing through them is equal, so A VGS of Q7 and a VGS of Q8 are also equal, resulting in I_{Q9}=(GND−SW)/R3 (R3=R4). I_{Q9} is replicated to IOUT2 through current mirrors Q11 and Q10. A voltage difference between IOUT2 and M1 is related to GND−SW=I_{M0}*R_{M1}. For the system, R_{M1} and R3 are both deterministic quantities, so IOUT2 can represent I_{M1}.

In another embodiment of the present disclosure, a synchronous buck charging circuit without external sampling resistors is further provided. The circuit is integrated into a charging management chip, and includes a high side power transistor, a low side power transistor, an inductor current sampling module, and a charging control module.

A drain of the high edge power transistor is connected to a power input terminal VIN of the chip (configured to receive 5V USB power), and its source is connected to a switch node of the chip. A drain of the low side power transistor is connected to the switch node, and its source is connected to a power ground PGND. The switch node is coupled to a positive electrode of a single lithium battery through an external inductor.

The inductor current sampling module has two input terminals, which are respectively coupled to the current detection terminal of the high side power transistor (e.g. through a mirror transistor) and the current detection terminal of the low side power transistor. The module internally includes a high edge sampling unit, a low edge sampling unit, and a synthesis unit.

The high side sampling unit is composed of a mirror tube proportional to the high side power transistor (such as 1: K). During a conduction period of the high side power transistor, the mirror tube outputs a first sampling current I_sense_H that is proportionally reduced, and its magnitude is proportional to the instantaneous current flowing through the high side power transistor.

The low side sampling unit is composed of a mirror tube proportional to the low side power transistor (such as 1: K). During a conduction period of the low side power transistor, the mirror tube outputs a second sampling current I_sense_L that is proportionally reduced, and its magnitude is proportional to the instantaneous current flowing through the low side power transistor.

The synthesis unit includes a common resistor and corresponding switch logic. The switch logic ensures that when the high side power transistor is conducting, I_sense_H flows through the common resistor; when the low side power transistor is conducting, I_sense_L flows through the common resistor. Thus, a continuously changing voltage is generated at two ends of the common resistor. The waveform of this voltage is exactly the same as the waveform of the inductor current, and its average value is proportional to the average inductor current, that is, proportional to the charging current I_chg.

The charging control module receives voltage as a current feedback signal and compares it with a reference voltage representing the target charging current. The charging control module contains a current loop error amplifier (not shown in the figures.), which adjusts the duty cycle of the PWM control signal output. By driving signals of HDRV and LDRV, it controls the conduction on and off of the high side power transistor and low side power transistor, respectively, to achieve closed-loop regulation of the charging current.

Due to the fact that the entire current detection process is completed inside the chip and no resistors are connected in series in the power main circuit, the conduction loss on traditional resistors is eliminated.

To achieve the purpose of the present disclosure, referring to FIG. 11, a current sampling control method for loss optimization based on the circuit without external sampling resistors is further provided, the method including the steps of:
during a first phase of a switching cycle, sampling a current flowing through a high side power transistor to obtain a first current sample;
during a second phase of the switching cycle, sampling a current flowing through the low side power transistor to obtain a second current sample, where the first phase does not overlap with the second phase and essentially covers the entire switching cycle;
continuously splicing the first current sample and the second current sample in time to reconstruct a complete inductor current waveform;
using a reconstructed inductor current waveform or its average value as a feedback signal for the charging current to adjust the charging current and achieve loss optimization.

The method further includes converting the spliced current signal into a voltage signal, and feeding back the voltage signal to a charging control loop to adjust conduction times of the high side power transistor and the low side power transistor.

To achieve the purpose of the present disclosure, a charging management chip is further provided, which integrates the synchronous buck charging circuit without external sampling resistors.

The chip only needs to be equipped with external components at its power input terminal, power ground terminal, switch node terminal, and battery connection terminal, without the need to configure sampling resistors for current detection.

To achieve the purpose of the present disclosure, an electronic device is provided, which includes a charging management chip, a standard 5V USB power interface, a single cell lithium battery, and
an external circuit that only includes an inductor, an input capacitor, and an output capacitor, where a switch node of the chip is coupled to the lithium battery through the inductor, and an input terminal of the chip receives a USB power supply.

The charging management chip is configured to provide a maximum charging current of 3.5 A to the single lithium battery, and there is no additional conduction loss caused by external power resistors on its internal current sampling path.

The present disclosure integrates the inductor current sampling module to time sample the currents of the high and low side power transistors and combine them into a continuous inductor current waveform, thereby replacing the external power sampling resistor in traditional solutions. This completely eliminates the approximately 122.5 mW conduction loss caused by the sampling resistor during high current charging (such as 3.5 A) while ensuring the accuracy of charging current control, reducing system temperature rise and improving charging safety and battery life; at the same time, eliminating the power resistor simplifies the peripheral circuit, reduces the PCB footprint, lowers material costs, and achieves a high-efficiency, highly integrated, and low-cost synchronous buck charging management solution.

That is to say, compared with the existing technology, the present disclosure replaces the external sampling resistor with an internal inductor current sampling module, completely eliminating the conduction loss caused by the large current flowing through the sampling resistor in the traditional solution (about) 122.5 mW@3.5 A), which reduced system temperature rise, improved charging safety and battery life.

Besides that, simplifying peripheral circuits and reducing system costs by eliminating the need for external precision sampling resistors reduces the number of material lists and circuit board footprint, thereby facilitating equipment miniaturization and lowering overall solution costs.

It can also achieve high-precision current control by combining the currents of high and low side power transistors through time-sharing sampling into a complete inductor current waveform. The reconstructed charging current information has high accuracy and can meet the control requirements of constant current charging.

Furthermore, by eliminating energy loss on the sampling resistor, more energy is transferred to the battery at the same input power, thereby improving overall charging efficiency.

The above embodiments only express several embodiments of the present disclosure, and their descriptions are more specific and detailed, but should not be understood as limiting the scope of the present disclosure. It should be noted that for those skilled in the art, several modifications and improvements can be made without departing from the inventive concept, which are within the protection scope of the present disclosure. Therefore, the protection scope of the present disclosure should be based on the appended claim.

What is claimed is:

1. A synchronous buck charging circuit without external sampling resistors, wherein the synchronous buck charging circuit comprises connection nodes configured to be coupled to a high side power transistor and a low side power transistor through an external inductor; and an inductor current sampling module with a first input terminal coupled to a current terminal of the high side power transistor for time-sharing sampling of a first current of the high side power transistor, and a second input terminal coupled to a current terminal of the low side power transistor for time-sharing sampling of a second current of the low side power transistor;
wherein the inductor current sampling module is configured to synthesize the first current and the second current sampled in a time-sharing manner into a continuous inductance current sensing signal;
the synchronous buck charging circuit further comprises an input terminal configured to receive the inductance current sensing signal, and an output terminal configured to drive the charging control module of the high side power transistor and the low side power transistor respectively;
wherein the charging control module adjusts a charging current based on the inductance current sensing signal;
wherein the synchronous buck charging circuit is configured to be without an external current sampling resistor.

2. The synchronous buck charging circuit without external sampling resistors according to claim 1, wherein the inductor current sampling module further comprises a high side sampling unit, a low side sampling unit, and a synthesis unit;
wherein the high side sampling unit is connected in parallel or mirrored with the high side power transistor and is configured to output a first sampling current proportional to its conduction current during a conduction period of the high side power transistor;
wherein the low side sampling unit is connected in parallel or mirrored with the low side power transistor and is configured to output a second sampling current proportional to its conduction current during a conduction period of the low side power transistor;
wherein the synthesis unit receives the first sampling current and the second sampling current respectively and splices them in a time domain into a continuous synthesis current, and the synthesis current represents an instantaneous current of the external inductor.

3. The synchronous buck charging circuit without external sampling resistors according to claim 2, wherein the synthesis unit comprises a common resistor;
the first sampling current and the second sampling current selectively flow through the common resistor.

4. The synchronous buck charging circuit without external sampling resistors according to claim 1, wherein the charging control module comprises a current loop error amplifier;
wherein a first input terminal of the current loop error amplifier receives a reference voltage representing a target charging current, a second input terminal of the current loop error amplifier receives a feedback voltage converted from the inductance current sensing signal, and an output of the current loop error amplifier is configured to control a Pulse-Width Modulation, (PWM) duty cycle.

5. A current sampling control method for loss optimization based on the synchronous buck charging circuit without external sampling resistors according to claim 1, wherein the method comprises the steps of:
during a first phase of a switching cycle, sampling a current flowing through the high side power transistor to obtain a first current sample;
during a second phase of the switching cycle, sampling a current flowing through the low side power transistor to obtain a second current sample, wherein the first phase does not overlap with the second phase and essentially covers the entire switching cycle;
continuously splicing the first current sample and the second current sample in time to reconstruct a complete inductor current waveform; and
using a reconstructed inductor current waveform or its average value as a feedback signal for the charging current to adjust the charging current and achieve loss optimization.

6. The current sampling control method for loss optimization based on the synchronous buck charging circuit without external sampling resistors according to claim 5, wherein the method further comprises:
converting the spliced current signal into a voltage signal, and feeding back the voltage signal to a charging control loop to adjust conduction times of the high side power transistor and the low side power transistor.

7. A charging management chip, which integrates the synchronous buck charging circuit without external sampling resistors according to claim 1.

8. The charging management chip according to claim 7, wherein the chip only needs to be equipped with external components at its power input terminal, power ground terminal, switch node terminal, and battery connection terminal, without the need to equip with sampling resistors for current detection.
